(19) United States
(12) Patent Application Publication
(10) Pub. No.: US 2024/0198440 A1
(43) Pub. Date: Jun. 20, 2024

(54) Sawing device and saw assembly

(71) Applicant: Festool GmbH, Wendlingen (DE)

(72) Inventor: Alexander LAUTENSCHLÄGER, Esslingen (DE)

(73) Assignee: Festool GmbH, Wendlingen (DE)

(21) Appl. No.: 18/540,030

(22) Filed: Dec. 14, 2023

(30) Foreign Application Priority Data
Dec. 16, 2022 (DE) 10 2022 213 777.9

(51) Int. Cl. B23D 47/12; B23D 45/02

(52) U.S. Cl. CPC B23D 47/126; B23D 45/024

(57) ABSTRACT

A sawing device containing a base part for supporting the sawing device on a base surface and a slide is provided. The slide is mounted on the base part so as to be displaceable in a translational manner via a linear guide. The sawing device includes a saw head which is rotatably mounted on the slide. A drive unit for rotationally driving a saw blade in a saw blade plane (S) is arranged on the saw head. In addition, at least one interface for selectively coupling an electrical energy storage device is arranged on the slide. The interface is electrically connected to the drive unit. Moreover, a saw assembly containing such a sawing device and at least one electrical energy storage device is presented. The electrical energy storage device is coupled to the sawing device via at least one interface.

### CROSS-REFERENCE TO RELATED APPLICATIONS

This patent application is based on and claims priority pursuant to 35 U.S.C. § 119 to German Patent Application No. 10 2022 213 777.9, filed on Dec. 16, 2022, at the German Patent Office, the entire disclosure of which is hereby incorporated by reference herein.

### BACKGROUND OF THE INVENTION

### Field of the Invention

The present invention relates to a sawing device and a saw assembly.

### BRIEF SUMMARY OF THE INVENTION

The invention relates to a sawing device comprising a base part for supporting the sawing device on a base surface. Furthermore, the sawing device comprises a slide which is mounted on the base part so as to be displaceable in a translational manner via a linear guide. Moreover, the sawing device comprises a saw head which is rotatably mounted on the slide. A drive unit for rotationally driving a saw blade in a saw blade plane is arranged on the saw head.

In addition, the invention is directed to a saw assembly having such a sawing device and at least one energy storage device.

Such sawing devices are also known by the term “compound mitre saws”.

In this regard, a support surface for a workpiece can be provided on the base part. A saw blade which is mounted on the saw head and rotatably coupled to the drive unit can thus be moved, on the one hand, relative to the work piece, in that the saw head is rotated relative to the slide.

On the other hand, the saw blade can be moved relative to the workpiece, in that the slide is displaced with respect to the base part. Of course, other combinations of these movements are also possible. Compound mitre saws are particularly suitable for cutting elongate workpieces, e.g. beams, planks or profiles, transversely to the longitudinal direction thereof.

It is also known to operate compound mitre saws on a mains supply, i.e. to supply them with the necessary operating power via a cable. Alternatively, such a sawing device can be supplied with the necessary electrical operating power by an electrical energy storage device which is arranged on the sawing device. Such sawing devices are referred to as battery-operated or rechargeable battery-operated. In order, in this alternative, to be able to provide a sufficient amount of power, the electrical energy storage device always has a certain weight and a certain volume. This can be a hindrance during operation of the sawing device.

Therefore, it is the object of the present invention to provide a saw assembly, i.e. a sawing device with an energy storage device, in which the electrical energy storage device, despite its volume and weight, has the least possible negative influence on the operation of the sawing device.

### BRIEF DESCRIPTION OF THE DRAWINGS

FIG. 1 shows an inventive saw assembly having an inventive sawing device in a perspective view, wherein a saw head is in an upper end position.

FIG. 2 shows the inventive sawing device of FIG. 1 in a perspective view.

FIG. 3 shows the inventive saw assembly of FIG. 1 in a side view.

FIG. 4 shows the inventive sawing device of FIG. 2 in a side view.

FIG. 5 shows the inventive saw assembly of FIGS. 1 and 3 in a plan view, wherein the saw head is illustrated in an upper end position and the lower end position of the saw head is indicated.

FIG. 6 shows a gripping module for a sawing device in a perspective view, wherein the gripping module is not actuated and is locked.

FIG. 7 shows the gripping module of FIG. 6 in a view cut along the plane VII in FIG. 6.

FIG. 8 shows the gripping module of FIGS. 6 and 7 in a perspective view, wherein the gripping module is unlocked.

FIG. 9 shows the gripping module of FIG. 8 in a view cut along the plane IX in FIG. 8.

FIG. 10 shows the gripping module of FIGS. 6 to 9 in a perspective view, wherein the gripping module is unlocked and is actuated.

FIG. 11 shows the gripping module of FIG. 10 in a view cut along the plane XI in FIG. 10.

### DETAILED DESCRIPTION OF THE INVENTION

The object is achieved by a sawing device which comprises a base part for supporting the sawing device on a base surface. Furthermore, the sawing device has a slide which is mounted on the base part so as to be displaceable in a translational via a linear guide. Moreover, the sawing device comprises a saw head which is rotatably mounted on the slide. A drive unit for rotationally driving a saw blade in a saw blade plane is arranged on the saw head. In addition, at least one interface for selectively coupling an electrical energy storage device is arranged on the slide. The interface is electrically connected to the drive unit. This configuration has several advantages. On the one hand, when the saw head is rotated relative to the slide, an electrical energy storage device possibly coupled to the interface does not have to be moved therewith. This movement is typically performed manually. The saw head is thus relatively lightweight and as a result can be moved easily and precisely by a user of the sawing device. Furthermore, the saw head is typically spring-loaded in a direction away from the base part. Therefore, without a user of the sawing device doing anything, the saw head is at maximum distance from the base part by reason of the spring load. By virtue of the interface being on the slide and not on the saw head, the spring which produces the spring load does not have to be designed to be able to simultaneously move the energy storage device. In particular, the effect of this spring in a sawing device in accordance with the present invention is always the same, irrespective of the weight of the electrical energy storage device. Therefore, a comparatively weak spring is sufficient. This also improves operating comfort because the user typically has to work against the spring load when processing a workpiece. Since the spring-loaded upward movement of the saw head regularly causes a closing movement of a protective cover of the sawing device, it is also possible in this way to guarantee a comparatively short closing time of the protective cover with high precision and reliability. Compared to a sawing device in which the interface for an electrical energy storage device is provided on the base part, the sawing device in accordance with the present invention has the advantage that the interface is positioned relatively close to the drive unit. Therefore, only a comparatively short distance is to be bridged in order to bring electrical current from the interface to the drive unit. Furthermore, during operation of the sawing device this distance is subjected only to comparatively small variations in length which can result from a rotation of the saw head with respect to the slide. The travel path of the slide does not need to be taken into consideration. The power supply can thus be provided easily with the aid of a comparatively short cable. Moreover, the interface in the sawing device in accordance with the invention is geometrically in an exposed position, so that it is easily accessible and an electrical energy storage device can be easily coupled to and uncoupled from the interface.

In the case of sawing devices in accordance with the invention, the saw blade plane, i.e. the plane in which the saw blade can rotate during operation of the sawing device, is defined irrespective of whether a saw blade is fastened to the drive unit or not. This is because the saw blade plane is determined by a flange plane of a fastening flange for the saw blade. The fastening flange is a component of the drive unit.

In one example, a control unit for the drive unit is positioned on the saw head in the immediate vicinity of the drive unit. The control unit can also be integrated into the drive unit. In another example, the control unit for the drive unit is arranged on the slide. The control unit is positioned preferably in the immediate vicinity of the interface. In the example last referred to, the control unit and the drive unit are coupled in terms of control e.g. via one or a plurality of signal cables.

In one variant, the sawing device comprises at least two interfaces for selectively coupling an electrical energy storage device in each case. The at least two interfaces are arranged on the slide and are electrically connected to the drive unit. Consequently, at least two electrical energy storage devices can be coupled to the sawing device via the at least two interfaces. In this manner, a comparatively large amount of electrical energy can be provided and so the sawing device can be operated independently of the mains supply for a comparatively long time period.

It is understood that, of course, more than two interfaces can also be arranged on the slide and can be electrically connected to the drive unit.

Each of the interfaces can have a receiving channel for receiving a coupling piece of the respectively allocated electrical energy storage device. The receiving channel can have an open end and a closed end, wherein a coupling direction of the allocated interface extends in an extension direction of the receiving channel in the direction towards the closed end of the receiving channel. A decoupling direction of the allocated interface extends in the extension direction of the receiving channel in the direction towards the open end of the receiving channel. An electrical energy storage device can thus be coupled to the interface, in that it engages with its coupling piece, which is formed in the broadest sense as a protrusion, into the receiving channel and is displaced in the direction towards the closed end of the receiving channel. In order to decouple the electrical energy storage device, the associated coupling piece is displaced along the receiving channel in the decoupling direction, i.e. in the direction towards the open end of the receiving channel. Therefore, the electrical energy storage device can be easily coupled to the interface and easily decoupled from the interface.

Electrical contacts can be arranged within the receiving channel and serve to transfer electrical energy between the electrical energy storage device and the interface. In addition, electrical contacts can be arranged within the receiving channel and serve to transfer data between the electrical energy storage device and the interface. In addition, mechanical retaining and/or locking elements can be provided in the interior of the receiving channel and serve to mechanically fix the electrical energy storage device to the interface.

In one embodiment, the extension directions of the receiving channels of the at least two interfaces run towards one another. The extension directions of the receiving channels of the interfaces are not in parallel with one another. On the contrary, they run towards one another in a V-shape. An angle between the extension directions is preferably less than 90°. This ensures that the receiving channels are accessible and electrical energy storage devices, more precisely the coupling pieces thereof, can be easily and reliably inserted into the receiving channels. At the same time, such a configuration of the receiving channels is space-saving.

The open ends of the receiving channels can be oriented in the same direction. A spaced interval between the open ends of the receiving channels can be larger than a spaced interval between the closed ends of the receiving channels. This means that a spaced interval between the open end of a first receiving channel and the open end of a second receiving channel is larger than a spaced interval between the closed end of the first receiving channel and the closed end of the second receiving channel. A comparatively large free space is thus available in the region of the open ends and so electrical energy storage devices can be easily and conveniently coupled to the interfaces. At the same time, the electrical energy storage devices can thus be arranged in a compact manner on the sawing device.

Preferably, the spaced interval between the open ends of the respective receiving channels is 30 mm to 70 mm. In one example, the spaced interval between the open ends of the respective receiving channels is 50 mm. This distance is large enough to allow a human hand to conveniently grip the electrical energy storage devices in a case where they are arranged on the interfaces.

In one variant, the extension directions of the receiving channels form an angle of 10° to 30°. Preferably, the angle is 15 to 25 degrees. In one example, an angle of 20 degrees is provided. An angle of this magnitude represents a good compromise between convenient coupling and decoupling and a compact arrangement.

In one alternative, in one operating position of the sawing device when viewed in each of the extension directions of the receiving channels in a direction towards the respectively allocated closed end, the saw head lies without overlap adjacent to the interface, which is allocated to the respective receiving channel, irrespective of a relative position of the saw head with respect to the slide. Therefore, the saw head never overlaps the interface in the extension directions of the respective receiving channels, regardless of the relative position in which it is located. The at least one interface is thus always accessible, and so an electrical energy storage device can always be coupled to and uncoupled from the interface without the saw head being an obstacle. In particular, the electrical energy storage device can be coupled to and uncoupled from the interface without the saw head having to be moved for this purpose.

The at least two interfaces can be arranged on a common coupling plane. Therefore, the receiving channels are provided on a common plane. This provides in good accessibility to the interfaces and electrical energy storage devices possibly coupled to the interfaces.

In one embodiment, the coupling plane is inclined by 10° or less with respect to the saw blade plane. This applies if the saw blade plane is oriented perpendicularly to the support surface. In other words, in one operating position of the sawing device, the coupling plane is inclined by 10° or less with respect to a vertical plane. In one example, in the operating position of the sawing device, the coupling plane is vertical or in parallel with the saw blade plane. In another example, the coupling plane is inclined slightly, i.e. by a maximum of 10 degrees, about a horizontal axis with respect to the saw blade plane and/or with respect to the vertical plane. Therefore, good accessibility to the coupling plane is ensured.

The object is also achieved by a saw assembly comprising a sawing device in accordance with the invention and at least one electrical energy storage device. The at least one electrical energy storage device is coupled to the sawing device via the at least one interface. The at least one electrical energy storage device can thus be easily and conveniently coupled to and uncoupled from the interface. The electrical energy storage device influences the operating behaviour of the sawing device only to an extremely little extent or not at all. Reference can also be made to the effects and advantages which have already been explained in connection with the sawing device in accordance with the invention.

According to one embodiment, the sawing device comprises at least two interfaces for selectively coupling an electrical energy storage device. The at least two interfaces are arranged on the slide and are electrically connected to the drive unit. An electrical energy storage device is coupled to each of the at least two interfaces. In this manner, a comparatively large amount of electrical energy can be provided and so the sawing device can be operated independently of the mains supply for a comparatively long time period.

Each of the energy storage devices can have an actuating element for actuating a locking mechanism for selectively locking and unlocking the energy storage device with respect to the sawing device. At least one of the actuating elements can point in the direction of the respective other energy storage device. The at least one actuating element thus points in the direction of the particular energy storage device, on which it is not arranged. Therefore, the at least two electrical energy storage devices can be designed as identical parts. Preferably, in the particular position in which the electrical energy storage devices are coupled to the respective interface, the actuating element is arranged in each case closer to the open end of the receiving channel than to the closed end of the receiving channel. This ensures that, in spite of a comparatively compact arrangement of the electrical energy storage devices, the actuating element is accessible in a convenient manner.

Preferably, the at least one actuating element is at a spaced interval of at least 12 mm from the respective other energy storage device. This means that a human finger can be positioned conveniently between the actuating element and the respective other energy storage device. Therefore, the actuating element can be easily and reliably actuated by a human finger.

According to one exemplified embodiment, in one operating position of the saw assembly in a plan view in the vertical direction, the saw head lies without overlap adjacent to the at least one energy storage device irrespective of a relative position of the saw head with respect to the slide. Therefore, the saw head never overlaps the at least one energy storage device, regardless of the relative position in which it is located. The at least one interface is thus likewise always accessible, and so an electrical energy storage device can always be coupled to and uncoupled from the interface without the saw head being an obstacle. In particular, the electrical energy storage device can be coupled to and uncoupled from the interface without the saw head having to be moved for this purpose. The same applies in relation to the extension directions of the receiving channels. That is to say that, when viewed in each of the extension directions of the receiving channels in a direction towards the respectively allocated closed end, the saw head lies without overlap adjacent to the energy storage device, which is coupled to the respective interface, irrespective of a relative position of the saw head with respect to the slide. The aforementioned effects and advantages are achieved.

The invention will be explained hereinafter with the aid of various exemplified embodiments which are illustrated in the drawings. In the drawings:

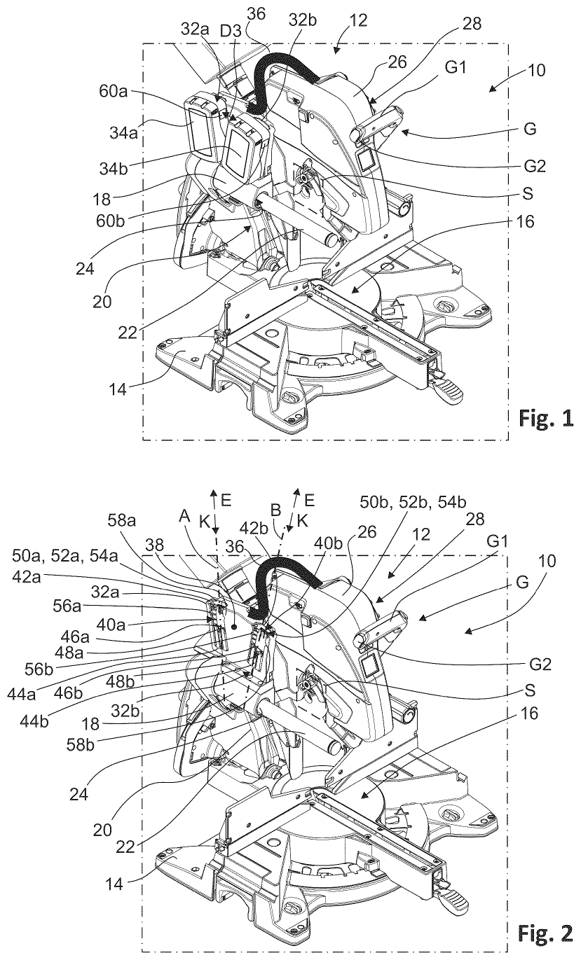

FIG. 1 shows a saw assembly 10.

The saw assembly 10 has a sawing device 12.

The sawing device 12 comprises a base part 14 for supporting the sawing device 12 on a base surface, not illustrated in greater detail.

Furthermore, a support surface 16 for mounting a workpiece to be processed by means of the sawing device 12 is provided on the base part 14. For the sake of improved clarity, a workpiece is not illustrated in the figures.

The sawing device 12 further comprises a slide 18.

This is mounted on the base part 14 so as to be displaceable in a translational manner via a linear guide 20.

In the illustrated exemplified embodiment, the linear guide 20 comprises a guide rod 22 which is oriented substantially horizontally in one operating position of the sawing device 12.

The guide rod 22 is fixedly connected to the base part 14.

Furthermore, a guide channel 24 is provided on the slide 18. The guide rod 22 engages into said guide channel such that, by reason of the cooperation between the guide rod 22 and guide channel 24, the slide 18 can be displaced substantially horizontally with respect to the base part 14.

In the illustrated exemplified embodiment, the guide rod 22 and the guide channel 24 also each have a circular cross-section. This allows the saw head 26, which will be explained later, to be able to rotate about the guide rod 22 so that oblique cuts are also made possible.

The saw head 26 is rotatably mounted on the slide 18.

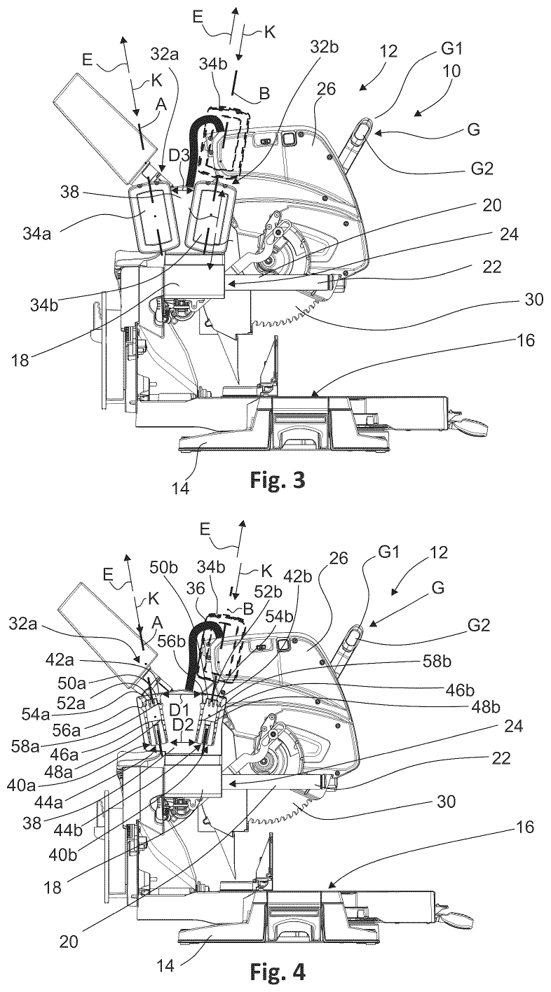

A drive unit 28 for rotationally driving a saw blade 30 in a saw blade plane S is arranged on the saw head 26. Accordingly, a saw blade 30 can be drivingly coupled to the drive unit 28. In the present case, the saw blade 30 can be seen only in the views of FIGS. 3 and 4. However, in those views in which the saw blade 30 is not illustrated and/or not mounted, the saw blade plane S is still clearly defined by a fastening flange for mounting the saw blade 30.

The fastening flange is a component of the drive unit 28.

The saw blade 30 can thus be moved relative to the workpiece or relative to the support surface 16 either by rotating the saw head 26 relative to the slide 18 or by displacing the slide 18 relative to the base part 14. Of course, these relative movements can also be combined.

Such sawing devices 12 are also referred to as compound mitre saws.

Said relative movements between the saw blade 30 and workpiece or support surface 16 are effected manually by a user of the saw assembly 10. For this purpose, a gripping module G which comprises a handle G1 and a power switch G2 is provided on the saw head 26. By actuating the power switch G2, the saw blade 30 is rotationally driven by means of the drive unit 28.

The sawing device 12 illustrated in the figures can be operated independently of mains supply.

Accordingly, two interfaces 32a, 32b are provided on the slide 18 (see also FIG. 2).

Each of the interfaces 32a, 32b is designed such that an electrical storage device 32 can be selectively coupled to the sawing device 12.

Both interfaces 32a, 32b are electrically connected to the drive unit 28 via a cable 36. The drive unit 28 can thus be operated by means of electrical energy from the electrical storage devices 34a, 34b.

In the present case, each energy storage device 34a, 34b has a width of ca. 80 mm and a height of ca. 140 mm. The thickness is ca. 35 mm. Each energy storage device 34a, 34b has a rated voltage of 18 V.

It is apparent from FIGS. 1 and 2 that, in the present case, the electrical energy storage devices 34a, 34b do not belong to the sawing device 12.

In contrast, the saw assembly 10 comprises the energy storage devices 34a, 34b and the sawing device 12.

In the present case, the two interfaces 32a, 32b are arranged on a common coupling plane 38.

The coupling plane 38 forms a planar surface, on which the two interfaces 32a. 32b are positioned.

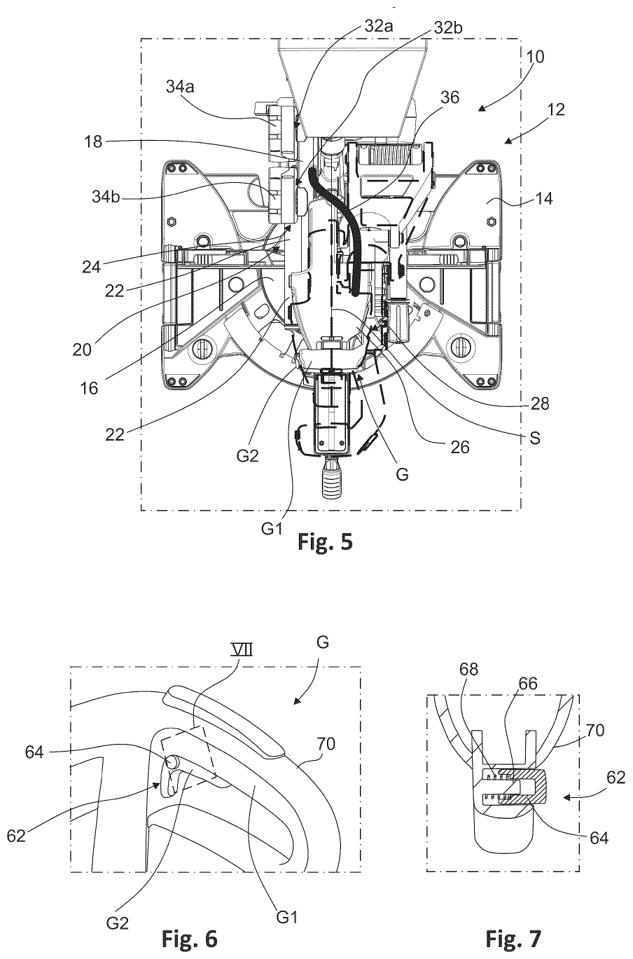

In the illustrated exemplified embodiment, the coupling plane 38 extends substantially in parallel with the saw blade plane S. Since the saw blade plane S is vertically oriented in one operating position of the sawing device 12, the coupling plane 38 also extends vertically in this position of the sawing device (see in particular FIGS. 4 and 5).

Each of the interfaces 32a. 32b comprises a receiving channel 40a, 40b for receiving a coupling piece of the respectively allocated electrical energy storage device 34a, 34b (see in particular FIGS. 2 and 4).

The receiving channel 40a extends in an extension direction A and the receiving channel 40b extends in an extension direction B.

Each of the receiving channels 40a, 40b has an open end 42a. 42b and a closed end 44a, 44b.

The open end 42a of the receiving channel 40a lies oppositely to the closed end 44a in the extension direction A. In the same manner, the open end 42b of the receiving channel 40b lies oppositely to the closed end 44b in the extension direction B.

Arranged within each of the receiving channels 40a, 40b are also two power contacts 46a. 46b, 48a, 48b, via which electrical energy from the electrical energy storage devices 34a, 34b can be introduced into the sawing device 12.

Furthermore, each of the receiving channels 40a, 40b comprises a total of three signal contacts 50a. 50b, 52a. 52b, 54a. 54b. Data can be exchanged between the respective interface 32a. 32b and the electrical energy storage device 34a, 34b, which is coupled thereto, via the signal contacts 50a. 50b, 52a, 52b, 54a, 54b.

Furthermore, each of the receiving channels 40a, 40b comprises two locking notches 56a. 56b, 58a, 58b which serve to lock the respectively allocated energy storage device 34a. 34b mechanically to the respectively allocated interface 32a. 32b.

As can be clearly seen in particular in FIG. 4, the extension directions A, B of the receiving channels 40a. 40b run towards one another in an V-shape.

The open ends 42a, 42b of the receiving channels 40a, 40b are oriented in the same direction.

In the illustrated exemplified embodiment, the open ends 42a. 42b point obliquely upwards (see in particular FIG. 4).

The V-shaped arrangement of the extension directions A. B thus ensures that a spaced interval D1 between the open ends 42a. 42b is larger than a spaced interval D2 between the closed ends 44a, 44b.

The spaced interval between the open ends 42a, 42b is 30 mm to 70 mm. In the present case, this spaced interval is ca. 50 mm.

The receiving channels 40a, 40b have a length of 100 mm to 200 mm.

Furthermore, in the illustrated exemplified embodiment, the extension directions A. B form an angle of ca. 15°.

In relation to the saw head 26, the interfaces 32a. 32b are arranged such that, in one operating position of the sawing device 12 in a plan view in the vertical direction, the saw head 26 lies without overlap adjacent to the interfaces 32a, 32b.

Furthermore, the interfaces 32a, 32b, when viewed in the extension directions A, B of the respectively allocated receiving channel 40a, 40b, lie without overlap adjacent to the saw head 26 irrespective of a relative position of the saw head 26 with respect to the slide 18. The view is always in one direction towards the allocated closed end 44a. 44b.

This applies irrespective of a relative position of the saw head 26 with respect to the slide 18, i.e. irrespective of a rotational position of the saw head 26.

Therefore, the electrical energy storage devices 34a. 34b can be coupled to the respective interface 32a, 32b in a coupling direction K of the respectively allocated interface 32a, 32b.

The coupling direction extends in the extension direction A, B of the respectively allocated receiving channel 40a, 40b in the direction towards the closed end 44a, 44b.

In order to couple the electrical energy storage devices 34a, 34b, a coupling piece of the respective energy storage device 34a, 34b is thus inserted in the coupling direction K into the respectively allocated receiving channel 40a. 40b. The power contacts 46a, 46b. 48a, 48b and signal contacts 50a. 50b, 52a. 52b, 54a, 54b are connected to respective mating contacts on the allocated energy storage device 34a, 34b.

Furthermore, latching lugs, not illustrated in greater detail, of each energy storage device 34a, 34b engage into the respective locking notches 56a. 56b, 58a, 58b.

Therefore, the energy storage devices 34a, 34b are coupled to the respective interfaces 32a, 32b electrically, mechanically and in terms of signal technology.

Furthermore, each energy storage device 34a, 34b has an actuating element 60a, 60b. The actuating elements 60a, 60b are designed to actuate a locking mechanism for selectively locking and unlocking the energy storage device 34a. 34b with respect to the sawing device 12. The latching lugs, not illustrated in greater detail, are components of these locking mechanisms.

Since the energy storage devices 34a, 34b are designed as identical parts in the present case, the actuating element 60a of the energy storage device 40a points in the direction of the energy storage device 40b.

The actuating element 60a is at a spaced interval D3 of at least 12 mm from the energy storage device 34b.

Therefore, in order to decouple the energy storage devices 34a, 34b both actuating elements 60a, 60b can be easily actuated by a human finger.

Furthermore, the saw assembly 10 is designed such that, in a plan view in the vertical direction, the saw head 26 lies without overlap adjacent to the energy storage devices 34a, 34b. Again, this applies irrespective of the relative position of the saw head 26 with respect to the slide 18.

Furthermore, the energy storage devices 34a, 34b, when viewed in the extension direction A, B of the respectively allocated receiving channel 40a, 40b, lie without overlap adjacent to the saw head 26 irrespective of a relative position of the saw head 26 with respect to the slide 18.

The view is always in one direction towards the allocated closed end 44a, 44b.

In this regard, FIG. 5 illustrates the saw head 26 in an upper end position with solid lines. The lower end position of the saw head 26 is indicated by dashed lines.

Moreover, FIGS. 3 and 4 illustrate an energy storage device 34b, which is displaced in the extension direction B and is guided past the saw head 26 without collision, as dashed lines for clarification.

Therefore, the energy storage devices 34a, 34b can be easily decoupled from the allocated interface 32a, 32b in the decoupling direction E thereof. The decoupling direction E extends in the extension direction A. B in the direction towards the open end 42a, 42b of the respective receiving channel 40a. 40b. It is understood that the energy storage devices 34a, 34b must be unlocked beforehand by means of the actuating element 60a, 60b.

FIGS. 6 to 11 illustrate an alternative gripping module G. This can be used instead of the gripping module G of the sawing device 12 of FIGS. 1 to 5.

In the views shown in FIGS. 6 and 7, the power switch G2 is not actuated.

In order to prevent unintentional actuation of the power switch G2, it is equipped with a switch-on locking assembly 62. This comprises a cup-shaped locking element 64 which is guided in a translational manner on a guide pin 66 arranged on the power switch G2. The locking element 64 is urged to an extended position by means of a spring 68. In this position, the locking element 64 protrudes with respect to the power switch G2. At the same time, the locking element is arranged outside a housing 70 of the gripping module G.

Actuation of the power switch G2 is thus blocked by virtue of the fact that the locking element 64 runs up against the housing 70.

Since the locking element 64 is circular-cylindrical when viewed from the outside, it can also be referred to as a locking pin or locking button.

In a case where the power switch G2 is to be actuated, it must first be unlocked.

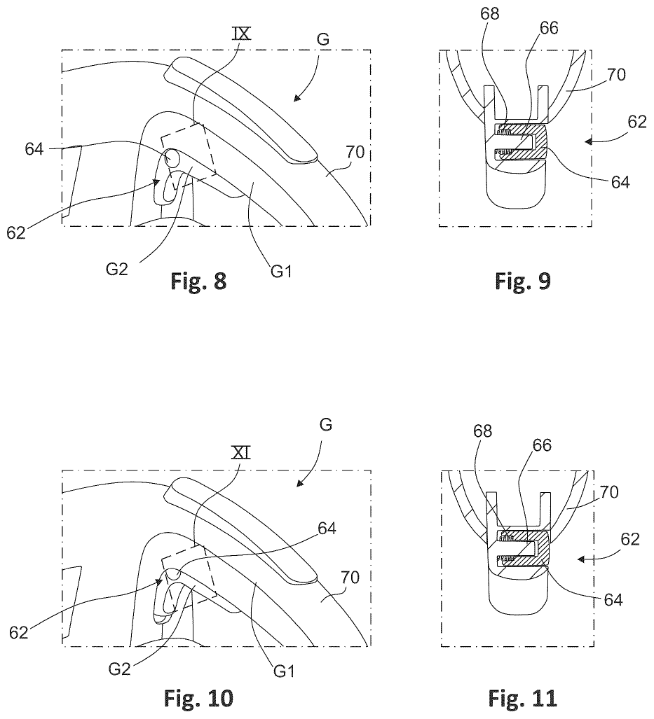

For this purpose, the locking element 64 must be pressed into the interior of the power switch G2 against the force of the spring 68. This can be seen in FIGS. 8 to 9.

An actuation path of the power switch G2 is now unblocked.

In the situation illustrated in FIGS. 8 and 9, the power switch G2 is unlocked but still not actuated.

FIGS. 10 to 11 show the actuated state of the power switch G2. By reason of the fact that the locking element 64 is located in the interior of the power switch G2 after unlocking, the power switch G2 can now be urged into the housing 70 together with the locking element 64. In this way, the sawing device 12 is actuated, i.e. the saw blade 30 is rotationally driven by means of the drive unit 28.

If the sawing device 12 is no longer actuated, the power switch G2 returns to the non-actuated state by reason of a spring load, not illustrated in greater detail. By reason of load exerted by the spring 68, the locking element 64 then also moves out of the power switch G2. Therefore, the power switch G2 is then locked.

List of reference signs

| | |
|---|---|
| 10 | saw assembly |
| 12 | sawing device |
| 14 | base part |
| 16 | support surface |
| 18 | slide |
| 20 | linear guide |
| 22 | guide rod |
| 24 | guide channel |
| 26 | saw head |
| 28 | drive unit |
| 30 | saw blade |
| 32a | interface |
| 32b | interface |
| 34a | electrical energy storage device |
| 34b | electrical energy storage device |
| 36 | cable |
| 38 | coupling plane |
| 40a | receiving channel |
| 40b | receiving channel |
| 42a | open end of the receiving channel 40a |
| 42b | open end of the receiving channel 40b |
| 44a | closed end of the receiving channel 40a |
| 44b | closed end of the receiving channel 40b |
| 46a | power contact of the receiving channel 40a |
| 46b | power contact of the receiving channel 40b |
| 48a | power contact of the receiving channel 40a |
| 48b | power contact of the receiving channel 40b |
| 50a | signal contact of the receiving channel 40a |
| 50b | signal contact of the receiving channel 40b |
| 52a | signal contact of the receiving channel 40a |
| 52b | signal contact of the receiving channel 40b |
| 54a | signal contact of the receiving channel 40a |
| 54b | signal contact of the receiving channel 40b |
| 56a | locking notch of the receiving channel 40a |
| 56b | locking notch of the receiving channel 40b |
| 58a | locking notch of the receiving channel 40a |
| 58b | locking notch of the receiving channel 40b |
| 60a | actuating element of the electrical energy storage device 34a |
| 60b | actuating element of the electrical energy storage device 34b |
| 62 | switch-on locking assembly |
| 64 | locking element |
| 66 | guide pin |
| 68 | spring |
| 70 | housing |
| A | extension direction of the receiving channel 40a |
| B | extension direction of the receiving channel 40b |
| D1 | spaced interval between the open ends of the receiving channels |
| | 40a, 40b |
| D2 | spaced interval between the closed ends of the receiving channels |
| | 40a, 40b |
| D3 | spaced interval between the actuating element 60a and the energy |
| | storage device 34b |
| E | decoupling direction |
| G | gripping module |
| G1 | handle |
| G2 | power switch |
| K | coupling direction |
| S | saw blade plane |

1. A sawing device comprising:
a base part for supporting the sawing device on a base surface,
a slide which is mounted on the base part so as to be displaceable in a translational manner via a linear guide, and
a saw head which is rotatably mounted on the slide,
wherein a drive unit for rotationally driving a saw blade in a saw blade plane is arranged on the saw head, and
wherein at least one interface for selectively coupling an electrical energy storage device is arranged on the slide and the at least one interface is electrically connected to the drive unit.

2. The sawing device as claimed in claim 1, comprising at least two interfaces for selectively coupling the electrical energy storage device in each case, wherein the at least two interfaces are arranged on the slide and are electrically connected to the drive unit.

3. The sawing device as claimed in claim 1, wherein the at least one interface has a receiving channel for receiving a coupling piece of the respectively allocated electrical energy storage device, wherein the receiving channel has an open end and a closed end, wherein a coupling direction of the allocated at least one interface extends in an extension direction of the receiving channel in the direction towards the closed end of the receiving channel and wherein a decoupling direction of the allocated at least one interface extends in the extension direction of the receiving channel in the direction towards the open end of the receiving channel.

4. The sawing device as claimed in claim 2, wherein the extension directions of the receiving channels of the at least two interfaces run towards one another.

5. The sawing device as claimed in claim 4, wherein open ends of the receiving channels are oriented in a same direction, and a spaced interval between the open ends of the receiving channels is larger than a spaced interval between the closed ends of the receiving channels.

6. The sawing device as claimed in claim 5, wherein the spaced interval between the open ends of the receiving channels is 30 mm to 70 mm.

7. The sawing device as claimed in claim 4, wherein the extension directions of the receiving channels form an angle of 10° to 30°.

8. The sawing device as claimed in claim 3, wherein in one operating position of the sawing device when viewed in each of the extension directions of the receiving channels in a direction towards a respectively allocated closed end, the saw head lies without overlap adjacent to the at least one interface, which is allocated to the respective receiving channel, irrespective of a relative position of the saw head with respect to the slide.

9. The sawing device as claimed in claim 2, wherein the at least two interfaces are arranged on a common coupling plane.

10. The sawing device as claimed in claim 9, wherein the common coupling plane is inclined by 10° or less with respect to the saw blade plane.

11. A saw assembly comprising a sawing device as claimed in claim 1 and at least one electrical storage device which is coupled to the sawing device via the at least one interface.

12. The saw assembly as claimed in claim 11, wherein the sawing device comprises at least two interfaces for selectively coupling an electrical storage device, the at least two interfaces are arranged on the slide and are electrically connected to the drive unit and an electrical energy storage device is coupled to each of the at least two interfaces.

13. The saw assembly as claimed in claim 12, wherein each of the electrical energy storage devices has an actuating element for actuating a locking mechanism for selectively locking and unlocking the electrical energy storage device with respect to the sawing device, and at least one of the actuating elements points in the direction of the respective other electrical energy storage device.

14. The saw assembly as claimed in claim 13, wherein the at least one actuating element is at a spaced interval of at least 12 mm from the respective other electrical energy storage device.

15. The saw assembly as claimed in claim 11, wherein in one operating position of the saw assembly in a plan view in the vertical direction, the saw head lies without overlap adjacent to the at least one electrical energy storage device irrespective of a relative position of the saw head with respect to the slide.
